(19) United States
(12) Patent Application Publication
(10) Pub. No.: US 2025/0182013 A1
(43) Pub. Date: Jun. 5, 2025

(54) SYSTEM AND METHOD CONFIGURED TO PREDICT PROBLEMS WITH PROJECTS AND TO GENERATE EARLY ALERTS USING ARTIFICIAL INTELLIGENCE

(71) Applicant: SAUDI ARABIAN OIL COMPANY, Dhahran (SA)

(72) Inventors: Haroon Awan, Dhahran (SA); Daniel E Castro, Dhahran (SA); Irslan Siddiq, Dhahran (SA)

(73) Assignee: SAUDI ARABIAN OIL COMPANY, Dhahran (SA)

(21) Appl. No.: 18/526,650

(22) Filed: Dec. 1, 2023

(51) Int. Cl. G06Q 10/0631; G06N 3/08

(52) U.S. Cl. CPC G06Q 10/06313; G06N 3/08

(57) ABSTRACT

A project management system and method are configured to predict problems with projects and to generate early alerts using artificial intelligence. The project management system comprises a processor, a memory, a feature extraction module, a machine learning module, and a project analysis module. The feature extraction module extracts a feature from project data associated with a project. The machine learning module implements a trained machine learning model, applies the extracted feature to the trained machine learning model, and predicts a state of the project. The project analysis module analyzes the predicted state using the artificial intelligence or other analysis techniques to initiate reporting the analyzed predicted state including generating and outputting the early alerts, remediating the project based on the analyzed predicted state, or both.

### FIELD OF THE DISCLOSURE

The present disclosure relates generally to generating alerts for projects, and, more particularly, to a system and method configured to predict problems with projects and to generate early alerts using artificial intelligence and in some implementations to remediate the predicted problems.

### BACKGROUND OF THE DISCLOSURE

Management of a project of an organization involves collecting, storing, managing, and interpreting data from many business activities of the organization involved with the project. Known Enterprise Resource Planning (ERP) systems track business resources directed to a given project, such as financial resources, raw materials, production capacity, and business commitments such as orders, purchase orders, and payroll. Software applications are available to process such business resources to calculate and even forecast an expected outcome based on a given input. For example, known software applications perform forecast estimation to identify and calculate estimated deviations to cost as well as to start and end dates of a project.

However, such known project management techniques are incapable of generating an alert of potential or future deviations of a project when there is no indication, based on current project data, that there is currently a problem, issue, or challenge to the progress or completion of the project. In standard project controls models in the prior art, alarms are triggered after the impact on project has already happened, for example, if a project procurement critical item has a float of thirty days. Using the typical model in the prior art, there are no generated alerts until the float has been depleted and the critical path of a project has been impacted.

### SUMMARY OF THE DISCLOSURE

According to an embodiment consistent with the present disclosure, a system and method are configured to predict problems, issues, or challenges with projects and to generate early alerts using artificial intelligence.

In an embodiment, a project management system comprises a communication interface, a hardware-based processor, a memory, and a set of modules. The communication interface is configured to receive project data corresponding to a project. The memory is configured to store instructions and configured to provide the instructions to the hardware-based processor. The set of modules is configured to implement the instructions provided to the hardware-based processor. The set of modules include a feature extraction module, a machine learning module, and a project analysis module. The feature extraction module is configured to extract a feature from the project data. The machine learning module is configured to implement a machine learning model, to apply the extracted feature to the machine learning model, and to predict a state of the project. The project analysis module is configured to analyze the predicted state and to initiate an action on the analyzed predicted state. The action is a reporting of the analyzed predicted state or a remediation of the analyzed predicted state.

The machine learning model can be trained using a predetermined training set of data. The set of modules can further comprise a remediation module configured to perform the remediation of the analyzed predicted state including remediating the project. Alternatively, the set of modules can further comprise a report generating module configured to perform the reporting of the analyzed predicted state including generating and outputting a report of the predicted state of the project. The report generating module can include an output device configured to output the report. The output device can be a display configured to display the report. The displayed report can include a text message classifying the analyzed predicted state of the project. Alternatively, thee displayed report can include a visual color indication using a predetermined color scheme. The visual color indication can classify the analyzed predicted state of the project. The predetermined color scheme can include a dark green color representing no issues with the project, a medium green color representing an earliest indication of a potential issue with the project, a light green color representing a potential delay of completion of the project, a yellow color representing the project being behind between 5% and 10% in a progress of the project, and a red color representing the project being greater than or equal to 10% behind in the progress of the project.

In another embodiment, a system comprises a data source, a network and a project management sub-system. The data source can provide project data corresponding to a project. The project management sub-system can comprise a communication interface, a hardware-based processor, a memory, and a set of modules. The communication interface is operatively connected to the data source through the network and is configured to receive the project data from the data source. The memory is configured to store instructions and configured to provide the instructions to the hardware-based processor. The set of modules is configured to implement the instructions provided to the hardware-based processor. The set of modules includes a feature extraction module, a machine learning module, and a project analysis module. The feature extraction module is configured to extract a feature from the project data. The machine learning module is configured to implement a machine learning model trained using a predetermined training set, to apply the extracted feature to the trained machine learning model, and to predict a state of the project. The project analysis module configured to analyze the predicted state and to initiate an action on the analyzed predicted state. The action is a reporting of the analyzed predicted state or a remediation of the analyzed predicted state.

The set of modules can further comprise a remediation module configured to perform the remediation of the predicted state including remediating the project. Alternatively, the set of modules can further comprise a report generating module configured to perform the reporting of the predicted state including generating and outputting a report of the predicted state of the project. The report generating module can include an output device configured to output the report classifying the predicted state of the project. The report can visually classify the predicted state with a color indication using a predetermined color scheme includes a dark green color representing no issues with the project, a medium green color representing an earliest indication of a potential issue with the project, a light green color representing a potential delay of completion of the project, a yellow color representing the project being behind between 5% and 10% in a progress of the project, and a red color representing the project being greater than or equal to 10% behind in the progress of the project.

In a further embodiment, a computer-based method comprises receiving project data from a data source corresponding to a project, extracting a feature from the project data, applying the extracted feature to a machine learning model implemented by a machine learning module, predicting a problem, issue, or challenge associated with the project using the machine learning model to generated a predicted state, analyzing the project from the predicted state using a project analysis module, and performing an action on the analyzed predicted state including reporting the predicted state or remediating the predicted state of the project.

Reporting of the analyzed predicted state can include displaying a report having a text message classifying the predicted state of the project. Alternatively, reporting the analyzed predicted state can include displaying a report having a visual color indication using a predetermined color scheme. The visual color indication can classify the predicted state of the project. The report can visually classify the analyzed predicted state with a color indication using a predetermined color scheme includes a dark green color representing no issues with the project, a medium green color representing an earliest indication of a potential issue with the project, a light green color representing a potential delay of completion of the project, a yellow color representing the project being behind between 5% and 10% in a progress of the project, and a red color representing the project being greater than or equal to 10% behind in the progress of the project. Analyzing the project can include applying artificial intelligence to the predicted state. The method can further comprise training the machine learning model using a predetermined training set.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic of a system, according to an embodiment.

FIG. 2 is a schematic of a computing device used in the embodiment.

FIG. 3 is a graphical illustration of indicators of performance of a project.

FIGS. 4A-4B are flowcharts of a method of operation of the system of FIG. 1.

FIG. 5 is a table of classifications of projects.

It is noted that the drawings are illustrative and are not necessarily to scale.

### DETAILED DESCRIPTION OF CERTAIN EMBODIMENTS OF THE DISCLOSURE

Example embodiments consistent with the teachings included in the present disclosure are directed to a system 100 and a computer-based method 400 configured to predict problems with projects and to generate early alerts using artificial intelligence. As described herein, a problem includes a situation or circumstances which adversely affect a project. Such situations or circumstances also include issues with aspects or components of the project, and challenges to the project affecting the completion of the project.

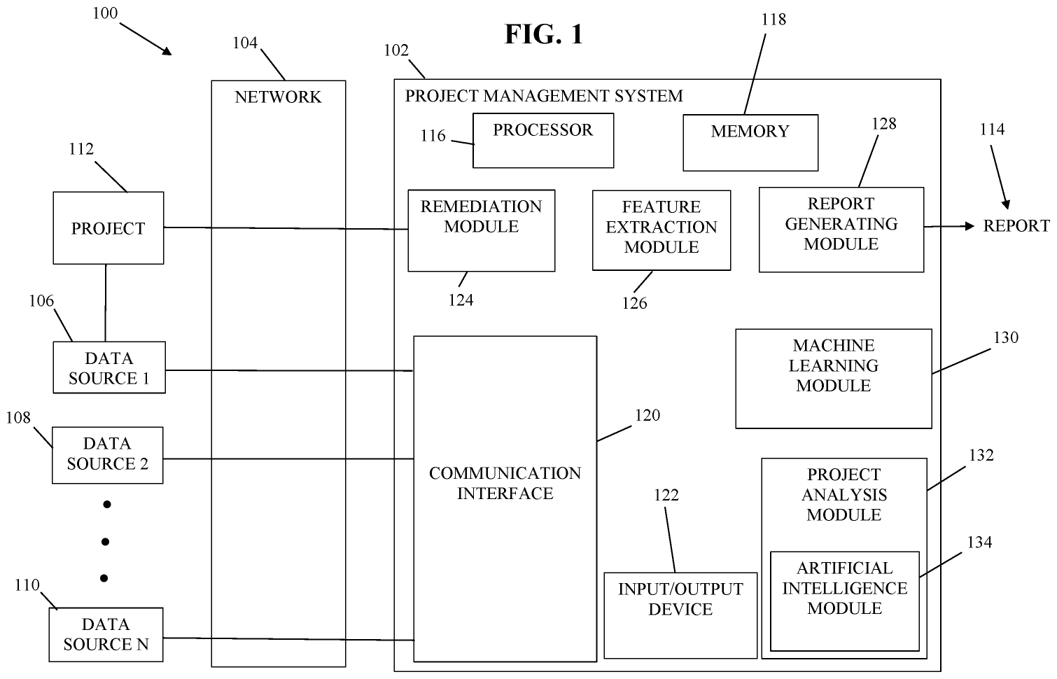

As shown in FIG. 1, the system 100 includes a project management system 102 operatively connected to a network 104. In an implementation consistent with the invention, the project management system 102 is a computer-based Enterprise Resource Planning (ERP) system configured to provide integrated management of main business processes and projects of an organization. In an alternative implementation, the project management system 102 is any known management system employing known management methods and techniques to manage processes and projects of an organization.

Through the network 104, the project management system 102 is operatively connected to at least one data source 106, 108, 110. In an implementation consistent with the invention, the project management system 102 is a system internal to an organization and configured to manage projects, for example, the project 112. In another implementation, the project management system 102 is a distributed system operatively connected to systems and devices throughout an organization. For example, the network 104 is the Internet. In another example, the network 104 is an internal network or intranet within an organization. In a further example, the network 104 is a heterogeneous or hybrid network including an intranet of an organization as well as at least a portion of the Internet. Still further, the network 104 is any known network.

In an implementation consistent with the invention, a data source 106, 108, 110 is any data source configured to store or provide project data. For example, the data source 106 is operatively connected to the project 112 to directly receive project data from the project 112. In one implementation, each of the data sources 106, 108, 110 stores the project data to be transmitted to the network management system 102 through the network 104. For example, each of the data sources 106, 108, 110 transmits the project data to the network management system 102 at a scheduled time, such as daily. In another example, the network management system 102 polls each of the data sources 106, 108, 110 for current or updated project data at a scheduled time, such as daily. In one implementation, the data sources 106, 108, 110 or the network management system 102 are configured to transmit or poll project data at a default time period, such as daily or any other periodic time interval. In another implementation, a system administrator, a project manager, or a project team sets the scheduled time or times using an input device; for example, the input/output device 122 described below.

In an alternative implementation, each of the data sources 106, 108, 110 conveys or otherwise provides the project data to the project management system 102 through the network 104 without permanently storing the project data. In one implementation, each data source 106, 108, 110 is a source of project management data, of data for construction progress, of data for remaining quantity analysis, of data from a simulation for uncertainty analysis, of data from a simulation for duration analysis, or any known source of project data for any type of project. For example, a project is in the sector or field of Engineering, Procurement, and Construction (EPC), and other industrial projects. Alternatively, a project is in the information technology (IT) sector, a research and development (R&D) sector, a biotech sector, a scientific sector, an agricultural sector, etc.

The network management system 102 is configured to operate on the project data of at least one project and to generate and output a report 114. The network management system 100 includes a hardware-based processor 116, a memory 118 configured to store instructions and configured to provide the instructions to the hardware-based processor 116, a communication interface 120, an input/output device 122, and a set of modules 124-134. The set of modules is configured to implement the instructions provided to the hardware-based processor 116. The set of modules include a remediation module 124, a feature extraction module 126, a report generating module 128, a machine learning module 130, and a project analysis module 132. In one implementation, the project analysis module 132 includes an artificial intelligence module 134, as described below. In an implementation, the communication interface 120 is configured to be operatively connected to the network 104 and to at least one data source 106, 108, 110. The input/output device 122 is configured to receive information from a user and to output information to a user. As described above, in an implementation, a system administrator, a project manager, or a project team sets up, configures, operates, or interacts with the network management system 102 using the input/output device 122.

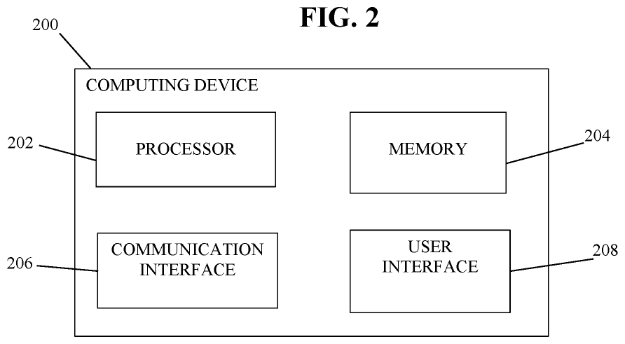

FIG. 2 illustrates a schematic of a computing device 200 including a processor 202 having code therein, a memory 204, and a communication interface 206. Optionally, the computing device 200 can include a user interface 208, such as an input device, an output device, or an input/output device. The processor 202, the memory 204, the communication interface 206, and the user interface 208 are operatively connected to each other via any known connections, such as a system bus, a network, etc. Any component, combination of components, and modules of the system 100 in FIG. 1 can be implemented by a respective computing device 200. For example, each of the components shown in FIG. 1 can be implemented by a respective computing device 200 shown in FIG. 2 and described below.

It is to be understood that the computing device 200 can include different components. Alternatively, the computing device 200 can include additional components. In another alternative embodiment, some or all of the functions of a given component can instead be carried out by one or more different components. The computing device 200 can be implemented by a virtual computing device. Alternatively, the computing device 200 can be implemented by one or more computing resources in a cloud computing environment. Additionally, the computing device 200 can be implemented by a plurality of any known computing devices.

The processor 202 can be a hardware-based processor implementing a system, a sub-system, or a module. The processor 202 can include one or more general-purpose processors. Alternatively, the processor 202 can include one or more special-purpose processors. The processor 202 can be integrated in whole or in part with the memory 204, the communication interface 206, and the user interface 208. In another alternative embodiment, the processor 202 can be implemented by any known hardware-based processing device such as a controller, an integrated circuit, a microchip, a central processing unit (CPU), a microprocessor, a system on a chip (SoC), a field-programmable gate array (FPGA), or an application-specific integrated circuit (ASIC). In addition, the processor 202 can include a plurality of processing elements configured to perform parallel processing. In a further alternative embodiment, the processor 202 can include a plurality of nodes or artificial neurons configured as an artificial neural network. The processor 202 can be configured to implement any known artificial neural network, including a convolutional neural network (CNN).

The memory 204 can be implemented as a non-transitory computer-readable storage medium such as a hard drive, a solid-state drive, an erasable programmable read-only memory (EPROM), a universal serial bus (USB) storage device, a floppy disk, a compact disc read-only memory (CD-ROM) disk, a digital versatile disc (DVD), cloud-based storage, or any known non-volatile storage.

The code of the processor 202 can be stored in a memory internal to the processor 202. The code can be instructions implemented in hardware. Alternatively, the code can be instructions implemented in software. The instructions can be machine-language instructions executable by the processor 202 to cause the computing device 200 to perform the functions of the computing device 200 described herein. Alternatively, the instructions can include script instructions executable by a script interpreter configured to cause the processor 202 and computing device 200 to execute the instructions specified in the script instructions. In another alternative embodiment, the instructions are executable by the processor 202 to cause the computing device 200 to execute an artificial neural network. The processor 202 can be implemented using hardware or software, such as the code. The processor 202 can implement a system, a sub-system, or a module, as described herein.

The memory 204 can store data in any known format, such as databases, data structures, data lakes, or network parameters of a neural network. The data can be stored in a table, a flat file, data in a filesystem, a heap file, a B+ tree, a hash table, or a hash bucket. The memory 204 can be implemented by any known memory, including random access memory (RAM), cache memory, register memory, or any other known memory device configured to store instructions or data for rapid access by the processor 202, including storage of instructions during execution.

The communication interface 206 can be any known device configured to perform the communication interface functions of the computing device 200 described herein. The communication interface 206 can implement wired communication between the computing device 200 and another entity. Alternatively, the communication interface 206 can implement wireless communication between the computing device 200 and another entity. The communication interface 206 can be implemented by an Ethernet, Wi-Fi, Bluetooth, or USB interface. The communication interface 206 can transmit and receive data over a network and to other devices using any known communication link or communication protocol.

The user interface 208 can be any known device configured to perform user input and output functions. The user interface 208 can be configured to receive an input from a user. Alternatively, the user interface 208 can be configured to output information to the user. The user interface 208 can be a computer monitor, a television, a loudspeaker, a computer speaker, or any other known device operatively connected to the computing device 200 and configured to output information to the user. A user input can be received through the user interface 208 implementing a keyboard, a mouse, or any other known device operatively connected to the computing device 200 to input information from the user. Alternatively, the user interface 208 can be implemented by any known touchscreen. The computing device 200 can include a server, a personal computer, a laptop, a smartphone, or a tablet.

Referring back to FIG. 1, the remediation module 124 is configured to remediate a project 112. In one implementation, the remediation module 124 modifies a feature of a project, for example, the project 112. In an example implementation, the modified feature includes a projected completion date of the project 112, with the remediation setting the projected completion date to a later date. In another implementation, the modified feature is configured to reduce or avoid a negative effect of the problem, issue, or challenge predicted to be associated with the project 112 by changing the value of a product parameter to better approximate continued performance with one or more reduced or avoided negative predicted effects. In a further implementation, the remediation module 124 generates and outputs a recommended remediation of the project 112 to a project manager or a project team, with the recommended remediation configured to reduce or avoid a negative effect of the problem, issue, or challenge predicted to be associated with the project 112.

In another implementation consistent with the invention, in the context of remediation by system 100 using the project management system 102 and in particular the remediation module 124, depending on the outcome of the machine learning model of the machine learning module 130 and the project analysis module 132, the machine learning model generates actionable measures for the project management system 102, in conjunction with a project manager or a project management team, to implement with respect to the project, so the impacts of potential or future problems, issues, or challenges are either minimized or eliminated. The actionable measures address such potential or future problems, issues, or challenges which are an indication of a specific set of activities on the critical path or on near critical path of the evaluated and monitored project. The layered approach of the system 100 works both top-down and bottom-up to find the particular designed triggers that could remain unidentified using standard project controls models in the prior art. In such standard project controls models in the prior art, alarms are triggered after the impact on project has already happened, for example, if a project procurement critical item has a float of thirty days. Using the typical model in the prior art, there are no generated alerts until the float has been depleted and the critical path of a project has been impacted.

In an implementation consistent with the invention, the system 100, complemented by artificial intelligence, triggers an alert as soon as the thirty day float starts depleting, and such a situation with a triggered alert is analyzed against the trained machine learning model of the machine learning module 130. The system 100 compares the situation against similar instances to assess whether an early alert is required. The system 100, using the machine learning model, also assesses an impact of the situation on the other related projects as well as an overall program. Moreover, the system 100 evaluates all the defined perimeters to trigger alerts that may be associated with the same cause or a different item requiring attention. hence covering the situation with the triggered alert from various angles. This Early Alert helps in addressing a problem, issue, or challenge of a project before the problem, issue, or challenge has any potential impact on the project or the overall program.

Referring to FIG. 1, the report generating module 128 is configured to generate the report 114 based on the output of the remediation module 124. In an implementation, the report 114 includes an early alert or an earliest alert. In another implementation, the report 114 includes a predicted state of the analyzed project. In a further implementation, the report 114 includes a status of the analyzed project. The report generation module 128 outputs the report 114 to a project manager or a project team. In one implementation, the report generation module 128 includes an output device configured to output the report 114. In another implementation, the report generation module 128 is operatively connected to an output device external to the project management system 102. In another implementation, such an output device can comprise a further module that acts without human intervention on the report 114 using code executing in a processor configured for that purpose, in lieu of a project manager or a project team. The code can comprise a separately trained machine learning system that tracks projects and events and is configured to align the progress of a given project, such as project 112, with other projects that have conforming features.

In one implementation, the output device is a printer or any known physical device configured to generate and output a physical hardcopy of the report 114. In another implementation, the output device is a display or monitor configured to display the report 114. For example, the displayed report 114 includes a text message classifying the analyzed predicted state of the project. In another example, the displayed report 114 includes a visual color indication using a predetermined color scheme, with the visual color indication classifying the analyzed predicted state of the project. In one implementation, the predetermined color scheme includes a dark green color representing no issues with the project, a medium green color representing an earliest indication of a potential issue with the project, a light green color representing a potential delay of completion of the project, a yellow color representing the project being behind between 5% and 10% in a progress of the project, and a red color representing the project being greater than or equal to 10% behind in the progress of the project. In another implementation, a different predetermined color scheme with different colors or different states represented by the colors is employed. In a further alternative implementation, the report generating module 128 generates and outputs an audio message as the report 114.

The feature extraction module 126 is configured to process the project data associated with a project from at least one data source 106, 108, 110, and configured to extract a feature of the project from the project data. Such features and other elements of a project are captured at a scheduled time from the project data. In one implementation, the scheduled time is a default time period, such as daily or any other periodic time interval. In another implementation, a system administrator, a project manager, or a project team sets the scheduled time or times using an input device, for example, the input/output device 122 described above.

In one implementation, the features extracted from the project data include a project name, a schedule uncertainty analysis parameter, a validating duration index, a total float burning ratio, a remaining project percentage complete per month, a delta slope value of a progress curve, a remaining quantity analysis parameter, and a manpower comparison parameter. The project name is a unique identifier that identifies a project being evaluated by the project management system 102. The schedule uncertainty analysis parameter is a result of quantification of potential risk and uncertainties that may affect the overall schedule of a project. In determining the schedule uncertainty analysis parameter, additional days are measured for the project completion date to reach a 90% confidence level (P90) as a result of a schedule simulation. For example, the schedule simulation uses a Monte Carlo-based simulation technique.

The validating duration index is a result of validation of the estimated duration of each task of a project and of the duration of the whole project against internal benchmarking to determine if the duration is realistic. The total float burning ratio is a measure of how much float is available for a project (TotalFloat) measured against how much float has already been consumed on a critical path of the project (ConsumedFloat). Accordingly, the total float burning ratio equals ConsumedFloat/TotalFloat. The remaining project percentage complete per month is a measure of the remaining construction percentage complete per month compared to historical data of completion of projects.

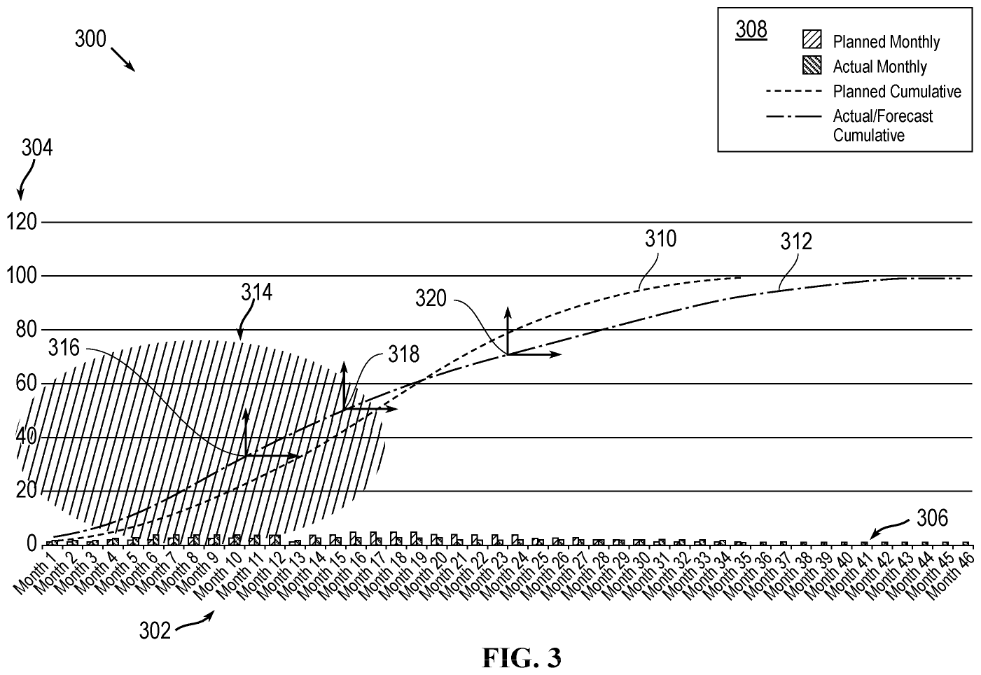

The delta slope value of a progress curve is a plan slope versus actual slope variance determined from the progress curves 310, 312 shown in FIG. 3 and described below. The remaining quantity analysis parameter is at least one or a combination of key quantities ratios, such as actual values versus plan values shown in FIG. 3 and described below. For example, the remaining quantity analysis parameter or parameters in a construction project include cement or concrete quantity values, steel quantity values, pipe quantity values, cable quantity values, quantity data values of equipment to be installed, etc. The manpower comparison parameter is a measure of an actual number of people working versus a planned number of people working, for example, at a worksite of a construction project.

In one implementation, the extracted features are combined in an arrangement of a set of data having the form of a matrix. A different matrix is created for various types of projects. For example, results of a construction project are different from results of a technology-based project. Therefore, appropriate features are extracted from the project data by the feature extraction module 126 for the types of results of the project. In one implementation, a matrix of extracted features with example values is shown in Table 1 below, with parameter A is the schedule uncertainty analysis parameter, parameter B is the validating duration index, parameter C is the total float burning ratio, parameter D is the remaining project percentage complete per month, parameter E is the delta slope value of a progress curve, parameter F is the remaining quantity analysis parameter, parameter G is the manpower comparison parameter, and the status is a prediction state of the project indicating whether the project is in danger or otherwise has no issues. The trained machine learning model determines and outputs the status from the extracted features in columns A through G inputted to the trained machine learning model.

TABLE 1

| PROJECT NAME | A | B | C | D | E | F | G | STATUS |
|---|---|---|---|---|---|---|---|---|
| Project 1 | 60 | 1.3 | 0.9 | 6% | −3 | 0.9 | 0.9 | YES |
| Project 2 | 10 | 0.8 | 1.2 | 2% | 4 | 1.1 | 1.2 | NO |
| Project 3 | 5 | 0.6 | 1.1 | 3% | 5 | 1.2 | 1.3 | NO |
| Project 4 | 100 | 1.5 | 0.9 | 8% | −4 | 0.85 | 0.7 | YES |

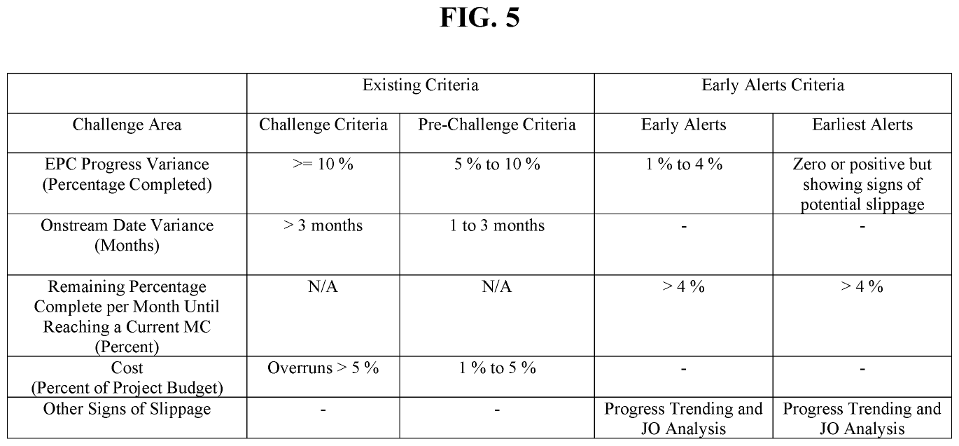

In one implementation, the machine learning model generates a classification of a project as in danger or otherwise has no issues based on a predetermined definition of project health according to the criteria shown in FIG. 5. The challenge areas in FIG. 5 identify issues of concern for a project, with the status of the project in Table 1 measured in relation to the existing challenge criteria or with early alerts criteria in FIG. 5. The EPC Progress Variance parameter measures a percentage of the project completed. The Onstream Date Variance parameter measures the changes between a planned onstream date and a forecast onstream date. In one implementation, the Onstream Data Variance parameter has the ultimate impact on the project, while the system 100 using the project management system 102 and the machine learning model, is configured to minimize or eliminate such an ultimate impact.

As described herein, a facility of an organization is considered on-stream when a Mechanical Completion Certificate (MCC) has been approved, a system or component of the facility, has been energized, or a product has been introduced into the facility. In addition, the product has been successfully operated during the start-up of the facility and handed over to an end user. In the construction industry, the MCC equates to the 100% completion of construction activities, and the phase of on-stream activity reaches a steady state of the use of the facility handed over to the end user.

Referring again to FIG. 5, the Remaining Percentage Complete per Month Until Reaching a Current MC parameter measures a remaining percentage of the project completed per month, in which “MC” refers to Mechanical Completion of the project. The Cost parameter measures a percent of a budget of a project. The Other Signs of Slippage parameter indicates a degree of progress trending and job order (JO) analysis. In one implementation consistent with the invention, a single Budget Item (BI), such as a particular project or a program, may have several job orders, including packages or contracts, within the Budget Item, depending on how the project work breakdown structure (WBS) is initially setup. Using the classifications in FIG. 5 generated by the machine learning model, the project analysis module 132 determines whether the project is in danger or otherwise has no issues, as described below.

As shown in Table 2 below in connection with the report generating module 128, Table 1, and FIG. 5, the predetermined color scheme used by the report generating module 128 corresponds to the classification of the predicted state of the project configured to generate early alerts and earliest alerts in the report 114.

TABLE 2

| Index | | | |
|---|---|---|---|
| Number | Classification | Color | Criteria |
| 1 | No Issues | Dark | Dashboard criteria. No warnings to be generated. |
| | | Green | Satisfactory |
| 2 | Earliest Alert | Green | Satisfactory classification (dashboard) showing earliest |
| | | | signs of potential issues. Projects with negative trending |
| | | | on EPC, contract award delays, purchase order (PO) |
| | | | placement delays, Issued for Construction (IFC) |
| | | | drawings production, etc. |
| 3 | Early Alert | Light | Satisfactory classification (dashboard), although |
| | | Green | showing signs of potential delays, such as slightly behind |
| | | | schedule on EPC and showing a declining slope on |
| | | | progress (last three months), challenging Construction |
| | | | progress per month to Mechanical Completion |
| 4 | Pre-Challenged | Yellow | Dashboard criteria. Behind on EPC progress (between 5 |
| | | | % and 10%) or late onstream (OS) date (one to three |
| | | | months), compared to a current plan |
| 5 | Challenged | Red | Dashboard criteria. Behind on EPC progress (more than |
| | | | 10%) or late onstream (OS) date (more than three |
| | | | months) compared to a current plan |

In an implementation consistent with the invention, the Earliest Alert and the Early Alert classifications in Table 2 are determined by the Early Alerts criteria shown in FIG. 5. In one implementation, using the classifications shown in Table 2, projects are grouped in buckets or sets with common features, such as all challenged projects in a red bucket, all pre-challenged projects in a yellow bucket, all early alert projects in a light green bucket, all earliest alert projects in a green bucket, and all satisfactory projects in dark green buckets. Each bucket or common feature set is associated with a budget item (BI).

In one implementation, as a project progresses, the machine learning model of the machine learning module 130 reclassifies the project into a different bucket. In an alternative implementation, a remediation action by the remediation module 124, as described above, modifies the project. The machine learning model of the machine learning module 130 reclassifies the modified project into a different bucket. Positive movement of a project occurs when a situation of the project improves between updates of the project. For example, a positive movement of a project to a better bucket occurs when a project is or becomes ahead or on schedule. In one implementation, even though there is positive movement of a project, the planned dates of the project remain unchanged. Negative movement of a project to a worse bucket occurs when a project gets behind schedule or when there is a change on one of the key dates, such as a Mechanical completion or an On Stream situation. A project has zero or neutral movement when there are no changes to a current health status of a project between update cycles.

The machine learning module 130 is configured to implement a machine learning model. The machine learning model is trained using a predetermined training set of data to perform a supervised machine learning technique. For example, the predetermined training set is a data sample categorizing a project as in danger, categorizing a project as having no issues, categorizing a project as having an earliest indication of a potential issue with the project, categorizing a project as having a potential delay of completion of the project, categorizing a project as having a state being behind between 5% and 10% in a progress of the project, and categorizing a project as having a state being greater than or equal to 10% behind in the progress of the project. In one implementation, the predetermined training set spans a predetermined range of time, such as five years or more of multiple projects.

In one implementation, the predetermined training set of data is stored or provided by at least one of the data sources 106, 108, 110. For example, the project management system 102 is configured to receive the predetermined training set of data from the at least one of the data source 106, 108, 110. The project management system 102 then stores the predetermined training set of data in the memory 118. In an implementation, the processor 116 provides the predetermined training set of data from the memory 118 to the machine learning module 130 to train the machine learning model. In another implementation, the processor 116 or the machine learning module 130 stores, in a database or a data store, the predetermined training set of data received from the at least one data source 106, 108, 110. In a further implementation, the predetermined training set of data is prestored in the memory 118.

In one implementation consistent with the invention, the machine learning module 130, implementing the machine learning model, includes an artificial neural network having a plurality of nodes or artificial neurons arranged in a plurality of layers, including an input layer and an output layer. Optionally, the artificial neural network includes at least one node or artificial neuron arranged in at least one hidden layer between the input and output layers. In an implementation, the artificial neural network is trained by the predetermined training set of data and is configured to receive and process input project data and extracted features at an input layer, and to generate a predicted state of the project at an output layer. For example, the extracted features and the status value of a project shown in Table 1 above are input to the input layer of the trained artificial neural network implementing the machine learning model of the machine learning module 130.

In another implementation consistent with the invention, the machine learning module 130 implementing the machine learning model includes a support vector machine receiving the extracted features and the status value of a project shown in Table 1 above as inputs. In a further implementation, the machine learning module 130 implementing the machine learning model includes a classifier receiving the extracted features and the status value of a project shown in Table 1 above as inputs. In an alternative implementation, the machine learning module 130 implementing the machine learning model includes any known machine learning technique. Using the trained machine learning model, the machine learning module 130 is configured to process the project data from the at least one data source 106, 108, 110 and the extracted features from the feature extraction module 126, such as the extracted features and the status value of a project shown in Table 1 above as inputs. The trained machine learning model of the machine learning module 130 is configured to generate a predicted project state from the extracted features and the status value of a project shown in Table 1 above as inputs associated with the project. In one implementation, the machine learning module 130, using the trained machine learning model, analyzes behavioral patterns of a project from the project data associated with the project.

The machine learning module 130, using the trained machine learning model, generates and outputs a predicted project state of the project predicting a future or potential state of the project. Using the predicted project state, the machine learning module 130 determines future or potential issues with the project from the behavioral patterns. The predicted project state includes data or a state associated with a problem, an issue, or a challenge with the project. For example, the predicted project state includes no issues with the project. In another example, the predicted project state includes an earliest indication of a potential issue with the project. In a further example, the predicted project state includes a potential delay of completion of the project. In still another example, the predicted project state includes the state of the project being behind between 5% and 10% in a progress of the project. In an additional example, the predicted project state includes the state of the project being greater than or equal to 10% behind in the progress of the project.

By applying the project data from the data sources 106, 108, 110 and the features extracted from such project data by the feature extraction module 126 to the machine learning model of the machine learning module 130, such project data and extracted features are processed through multiple analytical layers employing scripts and mathematical formulas implementing known industry best practices. In one implementation, the training of the machine learning model is based on behavior patterns of the project unique to the nature of the project, and so the project management system 102 produces relevant output alerts corresponding to each individual project instead of generating generic output alerts corresponding to a field or sector in which the project is classified.

The project analysis module 132 is configured to analyze the predicted project state, including the status shown in Table 1 and the classification shown in FIG. 5 indicating whether the project is in danger or otherwise has no issues. For example, the project analysis module 132 is configured to confirm the predicted project state from the predicted project state. In one implementation, the project analysis module 132 includes an artificial intelligence module 134 configured to process the predicted project state and any other data to confirm the predicted project state. For example, the artificial intelligence module 134 includes an artificial neural network having a plurality of nodes or artificial neurons arranged in a plurality of layers, including an input layer and an output layer. Optionally, the artificial neural network includes at least one node or artificial neuron arranged in at least one hidden layer between the input and output layers. In an implementation, the artificial neural network is trained by a predetermined training set of data and is configured to receive and process an input predicted state of the project from the machine learning module 130 at an input layer, and to generate an analyzed predicted state of the project at an output layer.

In another implementation consistent with the invention, the artificial intelligence module 134 includes a support vector machine. In a further implementation, the artificial intelligence module 134 includes a classifier. In an alternative implementation, the artificial intelligence module 134 includes any known artificial intelligence technique. Using the trained artificial intelligence module 134, the project analysis module 132 is configured to process the predicted state of the project, and is configured to generate an analyzed predicted project state associated with the project. In another implementation, the project analysis module 132 is configured to implement schedule uncertainty analysis, validating duration with regression analysis, total float consumption analysis, or multi-angle analysis to process the predicted project state and any other data to confirm the predicted project state.

In a further implementation, the project analysis module 132 is configured to implement any known data analysis technique to process the predicted project state and any other data to confirm the predicted project state. For example, the project analysis module 132 evaluates financial metrics, scheduling metrics, and project changes associated with the project being analyzed. The project analysis module 132 performs progress trending as well as package and sub-package analysis to evaluate contract award dates, equipment and material deliveries, equipment and material ordering sequencing, timing and deliveries, shutdown dates, variation in the slope of an actuals curve, depleting float, variation of interfaces, increasing monthly quantities to complete, past progress trending, future required progress, rate of resource deployment, key engineering deliverables completion dates, and potential delays on critical components having the potential to compromise the key milestone dates of completion of a project. In one implementation, the project analysis module 132 evaluates variations in the slope of an actuals curve, such as the curve 312 of cumulative actual values shown in FIG. 3 and described below.

After analyzing the predicted project state, the project analysis module 132 generates and outputs a notification or message regarding the project and the corresponding analyzed predicted project state. In one implementation, the notification or message indicates a confirmation that the analyzed project has a problem, an issue, or a challenge, allowing the project management system 102 to perform alert assessment for the project. In another implementation, the notification or message indicates that the analyzed project does not have a problem, an issue, or a challenge. Referring to the generated and outputted message, in one implementation, the message includes an instruction to add the analyzed project to a list of projects to be acted upon. In one implementation, the list of analyzed projects is stored in the memory 118. In another implementation, the list of analyzed projects is maintained as a queue in the processor 116 or the memory 118. In a further implementation, the list is stored or queued in the remediation module 124 or the report generating module 128, depending on an action to be performed on each analyzed project.

As described above, in one implementation, the action performed on each analyzed project includes remediating the project using the remediation module 124. In an alternative implementation, the action performed on each analyzed project includes generating and outputting the report 114 using the report generating module 124. In one implementation, the remediation action or the reporting action are automated. As described above, the report 114 includes color-coded early alerts of such future or potential issues visually output on a graphical dashboard displayed on a display or monitor of an output device. The report generating module 128 operates as a warning system configured to warn project management and executives of an organization of potential or future problems, other potential or future issues requiring early intervention in the conduct and performance of a project, or other potential or future challenges to completion of a project. In another implementation, the remediation action or the reporting action are performed manually, such as manual intervention by a project manager, a project team, or an executive of the organization. In a further implementation, the remediation action or the reporting action are performed manually in conjunction with automated actions by the project management system 102.

In another implementation, the notification or message described above includes an instruction to the machine learning module 130 to modify the machine learning model. For example, the instruction is a computer-based command to the machine learning module 130 to modify the machine learning model. In one implementation, modification of the machine learning model includes retraining the machine learning model using data from the analysis of the project by the project analysis module 132. In addition, project specific data is gathered into at least one dataset, and is stored in at least one of the data sources 106, 108, 110. The dataset is processed by the machine learning model. During operation of the system 100 and the project management system 102, every dataset is used to retrain the model. In one implementation, the dataset is captured, collected, or obtained from an ERP system, such as a commercially available SAP system or a commercially available Oracle system. In another implementation, the dataset is captured, collected, or obtained from any known ERP system. The dataset includes information, for example, from project schedules, progress reports, projects milestones, quantities, drawings, man hours, etc. The machine learning model is updated by any known machine learning (ML) technique or any known artificial intelligence (AI) technique at an established frequency of updating. For example, the machine learning model is updated using a supervised learning technique. The updating of the machine learning model is performed daily, weekly, monthly, or any other periodic time interval. In one implementation, the default time interval is daily. In another implementation, a system administrator, a project manager, or a project team sets the scheduled machine model updating time interval using an input device; for example, the input/output device 122 described above.

In an alternative implementation, the machine learning model is optimized. For example, the machine learning model is optimized using a known optimization technique. In one implementation of optimization, an analyst reviewing the results from the machine learning model marks false positives, and such false positive data is a retraining dataset. In another implementation, a reviewing module of the project management system 102 automates the reviewing of the results from the machine learning model, and automates the marking of false positives, with the false positive data as a retraining dataset. For example, the automating of the reviewing of the results and the marking of false positives by the reviewing module is performed using any known reviewing and false positive identification techniques.

The retraining dataset is fed back into the machine learning model to retrain the machine learning model. In one implementation, the performance of the machine learning model is reviewed with an established frequency to review the quality of the predictions being provided by the machine learning model. The established reviewing frequency of the machine learning model is performed daily, weekly, monthly, or any other periodic time interval. In one implementation, the default time interval is daily. In another implementation, a system administrator, a project manager, or a project team sets the scheduled machine model reviewing time interval using an input device; for example, the input/output device 122 described above. By optimizing the machine learning model, the accuracy of the predictions of the machine learning model becomes higher as the training iterations increase.

Referring to FIG. 3, a graphical illustration 300 displays indicators of performance of a project. In one implementation, the graphical illustration 300 includes a horizontal axis 302 and a vertical axis 304. For example, the graphical illustration 300 is output by an output device, such as a printer or a display. In one implementation, the output device is the input/output device 122 configured to display the graphical illustration 300 to a project manager or a project team. In another implementation, the output device is included in the report generating module 128 configured to display the graphical illustration 300 to the project manager or the project team. For example, the graphical illustration 300 is included in the report 114 output by the report generating module 128. In a further implementation, the output device is external to the project management system 102 and operatively connected to the report generating module 128, with the external output device configured to receive and output the report 114.

In one implementation, the horizontal axis 302 lists time-based indices for tracking progress of the project. For example, the time-based indices are labeled months such as Month 1, Month 2, etc. starting from the inception of the project. Alternatively, the time-based indices are absolute time values, such as actual dates starting from the inception of the project. In one implementation, the time-based indices is a default time period, such as by months or any other periodic time interval. The time period is used by the report generating module 128 to generate and output the graphical illustration 300 of the progress of the project with the time-based indices listed on the horizontal axis 302. In another implementation, a system administrator, a project manager, or a project team sets the time-based indices using an input device, for example, the input/output device 122 described above.

In one implementation, the vertical axis 304 lists a metric measuring the progress of the project. For example, the metric measures the degree or percentage of completion of the project ranging from zero percent to one-hundred percent. In one implementation, the curve 310 shown in FIG. 3 and described below represents a planned distribution of the completion of the project, and the curve 312 shown in FIG. 3 and described below represents the actual or forecast distribution of the completion of the project. Accordingly, both curves 310, 312 nearing completion of the project approach or attain a 100% completion state. In an alternative implementation, the vertical axis 304 shown in FIG. 3 lists a metric measuring a relative degree or level of activity involving the project, such as a value of sixty indicating intermediate activity of performing the project, and a value of one-hundred twenty indicating a relatively high level of activity of performing the project. For example, in FIG. 3, the value of one-hundred twenty is shown as the maximum value of activity of the project on the vertical axis 304.

In one implementation, the metric used to display the progress of the project on the vertical axis 304 is a default metric, such as percentage completion of the project. The metric is used by the report generating module 128 to generate and output the graphical illustration 300 of the progress of the project with the metric listed on the vertical axis 304. In another implementation, a system administrator, a project manager, or a project team sets the metric using an input device, for example, the input/output device 122 described above.

In one implementation, the graphical illustration 300 displays bars 306 indicating planned values associated with the project in a first color, and actual or forecast values associated with the project in a second color. For example, the planned values and actual or forecast values are displayed on a monthly basis. Alternatively, the planned values and actual or forecast values are displayed according to the time-based indices set by a system administrator, a project manager, or a project team as described a above. In one implementation, the monthly planned values and the monthly actual or forecast values are contract (CONT) values in a first color, and actual or forecast contract values in a second color, respectively, with the contract values associated with the project. The cumulative planned values 310 and the cumulative actual or forecast values 312 are displayed as curves or line segments in a graph with the axes 302, 306 on the graphical illustration 300.

The graphical illustration optionally displays a legend 308 indicating the colors of the planned monthly values, the actual or forecast monthly values, the cumulative planned values, and the cumulative actual or forecast values associated with the project. In one implementation, the planned monthly values, the actual or forecast monthly values, the cumulative planned values, and the cumulative actual or forecast values are planned monthly contract values, the actual or forecast monthly values, the cumulative planned contract values, and the cumulative actual or forecast contract values, respectively.

A region 314 of the graph represents a portion of the graph in which indicators 316, 318 on the curve of the cumulative actual or forecast values 312 are leading indicators. A leading indicator represents a point on the graph when the cumulative actual or forecast values 312 are greater than the cumulative planned values 310. For example, the indicator 316 is an early leading indicator, and the indicator 318 is a leading indicator at a point later than an earlier leading indicator. As the project progresses, preferably the cumulative actual or forecast values 312 are greater than the cumulative planned values 310. Unfortunately, in some circumstances, a project experiences delays as the project progresses. Accordingly, as shown in FIG. 3, due to such project delays, the cumulative actual or forecast values 312 become less than the cumulative planned values 310. Accordingly, the indicator 320 represents a lagging indicator representing the cumulative actual or forecast values 312 as less than the cumulative planned values 310.

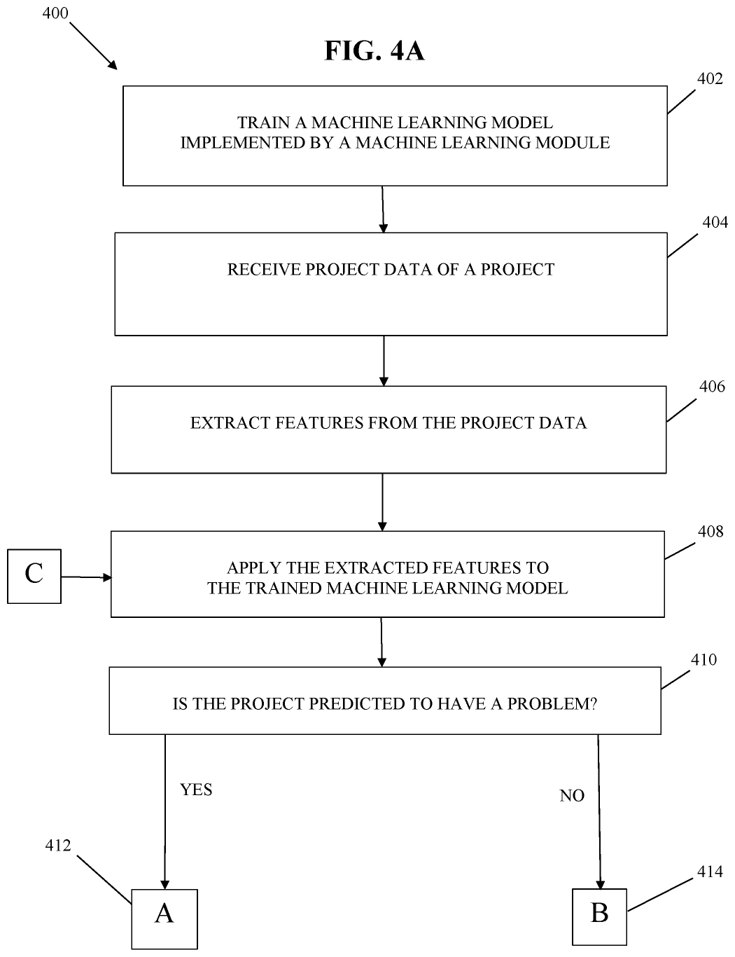

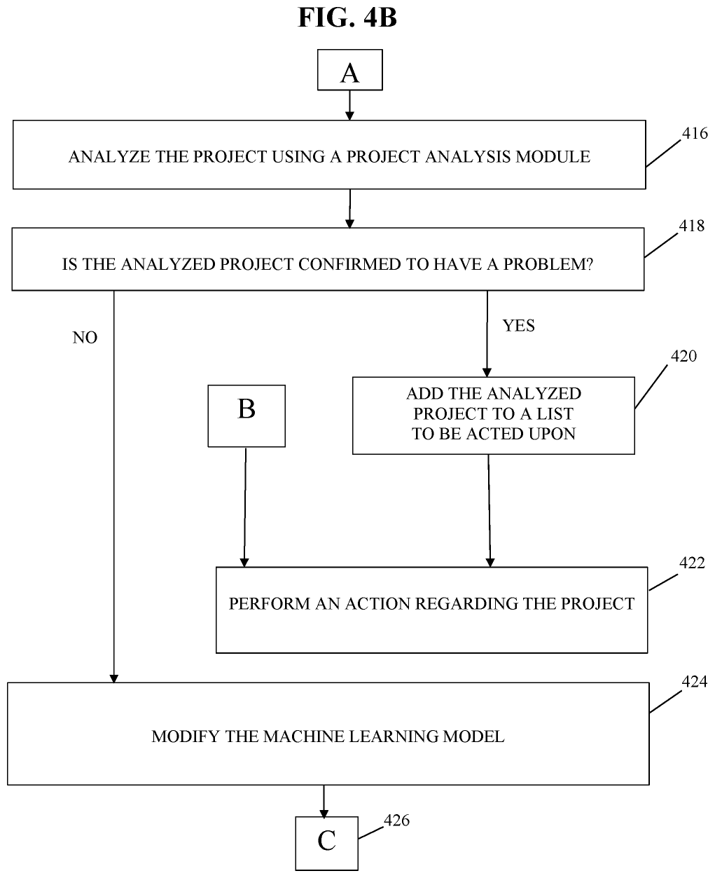

Referring to FIGS. 4A-4B, the computer-based method 400 includes the steps of training a machine learning model implemented by the machine learning module 130 in step 402 using a predetermined training set of data. In an implementation, the predetermined training set of data is stored or provided by at least one of the data sources 106, 108, 110. For example, the project management system 102 is configured to receive the predetermined training set of data from the at least one of the data source 106, 108, 110. The project management system 102 then stores the predetermined training set of data in the memory 118. In an implementation, the processor 116 provides the predetermined training set of data from the memory 118 to the machine learning module 130 to train the machine learning model. In another implementation, the processor 116 or the machine learning module 130 stores, in a database or a data store, the predetermined training set of data received from the at least one data source 106, 108, 110. In a further implementation, the predetermined training set of data is prestored in the memory 118.

The method 400 then receives project data of a project in step 404 from at least one data source 106, 108, 110. The method 400 extracts features from the project data in step 406. The method 400 then applies the extracted features to the trained machine learning model in step 408, and determining the case that the project is predicted by the machine learning model to have a problem in step 410. If so, the method 400 proceeds to step 412. Otherwise, the method 400 proceeds to step 414. After step 412, the method 400 analyzes the project by analyzing the predicted project state using the project analysis module 132 in step 416. In one implementation, the project analysis module 132 includes the artificial intelligence module 134 configured to analyze the predicted project state using a known artificial intelligence technique.

The method 400 then determines the case that the analyzed project is confirmed to have a problem in step 418. If so, the method 400 adds the analyzed project to a list to be acted upon in step 420. In one implementation, the list of analyzed projects is stored in the memory 118. In another implementation, the list of analyzed projects is maintained as a queue in the processor 116 or the memory 118. In a further implementation, the list is stored or queued in the remediation module 124 or the report generating module 128, depending on an action to be performed on each analyzed project.

The method 400 performs an action regarding the project in step 422. Referring back also to step 414, the method 400 proceeds to step 422 to perform an action regarding the project. In an implementation, the action performed in step 422 is a reporting of the analyzed predicted state in a report 114. The reporting is performed by the report generation module 128 configured to generate and output the report 114. In an implementation, the report 114 includes a predicted state of the analyzed project. In another implementation, the report 114 includes a status of the analyzed project. The report generation module 128 outputs the report 114 to a project manager or a project team. In one implementation, the report generation module 128 includes an output device configured to output the report 114. In another implementation, the report generation module 128 is operatively connected to an output device external to the project management system 102.

In one implementation, the output device is a printer or any known physical device configured to generate and output a physical hardcopy of the report 114. In another implementation, the output device is a display or monitor configured to display the report 114. For example, the displayed report 114 includes a text message classifying the analyzed predicted state of the project. In another example, the displayed report 114 includes a visual color indication using a predetermined color scheme, with the visual color indication classifying the analyzed predicted state of the project. In one implementation, the predetermined color scheme includes a dark green color representing no issues with the project, a medium green color representing an earliest indication of a potential issue with the project, a light green color representing a potential delay of completion of the project, a yellow color representing the project being behind between 5% and 10% in a progress of the project, and a red color representing the project being greater than or equal to 10% behind in the progress of the project. In an alternative implementation, the report generating module 128 generates and outputs an audio message as the report 114.

Alternatively, referring back to step 422, the action performed in step 422 is a remediation of the project by remediation of the analyzed predicted state using the remediation module 124. For example, the remediation module 124 is operatively connected to the project 112 analyzed by the project analyzed module 132 and associated with the data source 106 through the network 104. Alternatively, the analyzed project is associated with the data source 108 or the data source 110. The remediation module 124 then remediates the analyzed project. In one implementation, the remediation module 124 modifies a feature of the project, such as a projected completion data of the project. The modified feature is configured to reduce or avoid a negative effect of the problem predicted to be associated with the project. In another implementation, the remediation module 124 generates and outputs a recommended remediation of the project to a project manager or a project team, with the recommended remediation configured to reduce or avoid a negative effect of the problem predicted to be associated with the project.

Referring back to step 418, in the case that the analyzed project is not confirmed to have a problem, the method 400 proceeds to modify the machine learning model in step 424. For example, in step 424, the machine learning model is retrained. In an implementation, the machine learning model is retrained in step 424 using data from the analysis of the project. Alternatively, the machine learning model is optimized in step 424. After step 424, the method 400 proceeds to step 426 to loop back to apply the extracted features to the machine learning model in step 408, with the machine learning model having been retrained or optimized in step 424.

In operation, the system 100 and method 400 approach every project as unique with elements and features of the project identified to trigger possible alerts with an earliest assessment on potential project issues, even when all of the parameters and project data of a project are positive, are green, or present no issues. The system 100 and method 400 are adaptable to any industry and to any project in which known project management practices are being used. The system 100 and method 400 offer a centralized solution to raise alerts based on such a diverse collection of project-related metrics and a trending of the project-related metrics over time.

Portions of the methods described herein can be performed by software or firmware in machine readable form on a tangible or non-transitory storage medium. For example, the software or firmware can be in the form of a computer program including computer program code adapted to cause the system to perform various actions described herein when the program is run on a computer or suitable hardware device, and where the computer program can be embodied on a computer readable medium. Examples of tangible storage media include computer storage devices having computer-readable media such as disks, thumb drives, flash memory, and the like, and do not include propagated signals. Propagated signals can be present in a tangible storage media. The software can be suitable for execution on a parallel processor or a serial processor such that various actions described herein can be carried out in any suitable order, or simultaneously.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A project management system, comprising:
a communication interface configured to receive project data corresponding to a project;
a hardware-based processor;
a memory configured to store instructions and configured to provide the instructions to the hardware-based processor; and
a set of modules configured to implement the instructions provided to the hardware-based processor, the set of modules including:
a feature extraction module configured to extract a feature from the project data;
a machine learning module configured to implement a machine learning model, to apply the extracted feature to the machine learning model, and to predict a state of the project; and
a project analysis module configured to analyze the predicted state and to initiate an action on the analyzed predicted state,
wherein the action is a reporting of the analyzed predicted state or a remediation of the analyzed predicted state.

2. The project management system of claim 1, wherein the machine learning model is trained using a predetermined training set of data.

3. The project management system of claim 1, wherein the set of modules further comprises:
a remediation module configured to perform the remediation of the analyzed predicted state including remediating the project.

4. The project management system of claim 1, wherein the set of modules further comprises:
a report generating module configured to perform the reporting of the analyzed predicted state including generating and outputting a report of the predicted state of the project.

5. The project management system of claim 4, wherein the report generating module includes an output device configured to output the report.

6. The project management system of claim 5, wherein the output device is a display configured to display the report.

7. The project management system of claim 6, wherein the displayed report includes a text message classifying the analyzed predicted state of the project.

8. The project management system of claim 6, wherein the displayed report includes a visual color indication using a predetermined color scheme,
wherein the visual color indication classifies the analyzed predicted state of the project.

9. The project management system of claim 8, wherein the predetermined color scheme includes a dark green color representing no issues with the project, a medium green color representing an earliest indication of a potential issue with the project, a light green color representing a potential delay of completion of the project, a yellow color representing the project being behind between 5% and 10% in a progress of the project, and a red color representing the project being greater than or equal to 10% behind in the progress of the project.

10. A system, comprising:
a data source providing project data corresponding to a project;
a network; and
a project management sub-system, comprising:
a communication interface operatively connected to the data source through the network and configured to receive the project data from the data source;
a hardware-based processor;
a memory configured to store instructions and configured to provide the instructions to the hardware-based processor; and
a set of modules configured to implement the instructions provided to the hardware-based processor, the set of modules including:
a feature extraction module configured to extract a feature from the project data;
a machine learning module configured to implement a machine learning model trained using a predetermined training set, to apply the extracted feature to the trained machine learning model, and to predict a state of the project; and
a project analysis module configured to analyze the predicted state and to initiate an action on the analyzed predicted state,
wherein the action is a reporting of the analyzed predicted state or a remediation of the analyzed predicted state.

11. The system of claim 10, wherein the set of modules further comprises:
a remediation module configured to perform the remediation of the predicted state including remediating the project.

12. The system of claim 10, wherein the set of modules further comprises:
a report generating module configured to perform the reporting of the predicted state including generating and outputting a report of the predicted state of the project.

13. The system of claim 12, wherein the report generating module includes an output device configured to output the report classifying the predicted state of the project.

14. The system of claim 12, wherein the report visually classifies the predicted state with a color indication using a predetermined color scheme includes a dark green color representing no issues with the project, a medium green color representing an earliest indication of a potential issue with the project, a light green color representing a potential delay of completion of the project, a yellow color representing the project being behind between 5% and 10% in a progress of the project, and a red color representing the project being greater than or equal to 10% behind in the progress of the project.

15. A computer-based method, comprising:
receiving project data from a data source corresponding to a project;
extracting a feature from the project data;
applying the extracted feature to a machine learning model implemented by a machine learning module;
predicting a problem associated with the project using the machine learning model to generate a predicted state;
analyzing the project from the predicted state using a project analysis module; and
performing an action on the analyzed predicted state including reporting the predicted state or remediating the predicted state of the project.

16. The method of claim 15, wherein reporting the analyzed predicted state includes displaying a report having a text message classifying the predicted state of the project.

17. The method of claim 15, wherein reporting the analyzed predicted state includes displaying a report having a visual color indication using a predetermined color scheme,
wherein the visual color indication classifies the predicted state of the project.

18. The method of claim 17, wherein the report visually classifies the analyzed predicted state with a color indication using a predetermined color scheme includes a dark green color representing no issues with the project, a medium green color representing an earliest indication of a potential issue with the project, a light green color representing a potential delay of completion of the project, a yellow color representing the project being behind between 5% and 10% in a progress of the project, and a red color representing the project being greater than or equal to 10% behind in the progress of the project.

19. The method of claim 15, wherein analyzing the project includes applying artificial intelligence to the predicted state.

20. The method of claim 15, further comprising:
training the machine learning model using a predetermined training set.
